(19) United States
(12) Patent Application Publication
(10) Pub. No.: US 2005/0175020 A1
(43) Pub. Date: Aug. 11, 2005

(54) Tunneling service method and system

(75) Inventors: Soo-hong Park, Yongin-si (KR); Young-keun Kim, Incheon Metropolitan-City (KR); Pyung-soo Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/971,062

(22) Filed: Oct. 25, 2004

(30) Foreign Application Priority Data
Feb. 5, 2004 (KR) 2004-7669

(51) Int. Cl. H04L 12/66; H04L 12/56

(52) U.S. Cl. 370/400; 370/352; 370/466

(57) ABSTRACT

A tunneling service method and system enabling data communication between different networks, in which an address of a tunneling service server used in a client node can be easily designated, the tunneling service method includes: transmitting an information request message, which requests information required for connection to the network, to a dynamic host configuration protocol (DHCP) server selected by the client node; receiving an acknowledgement message, which contains an address of the tunnel router, from the DHCP server selected by the client node; and the client node detecting the address of the tunnel router contained in the acknowledgement message and generating a packet for a tunneling service using the detected address of the tunnel router.

### CROSS-REFERENCE TO RELATED APPLICATION

This application claims the benefit of Korean Patent Application No. 2004-7669 filed on Feb. 5, 2004, in the Korean Intellectual Property Office, the disclosure of which is incorporated herein in its entirety by reference.

### BACKGROUND OF THE INVENTION

1. Field of the Invention

The present invention relates to a tunneling service enabling data communications between communication networks, and more particularly, to a tunneling service method and system enabling data communications between a client node having an IPv4/6 (Internet Protocol version 4/6) dual stack and a client node in a different network.

2. Description of the Related Art

Internet communication networks are categorized into IPv4 (Internet Protocol version 4)-based communication networks and IPv6 (Internet Protocol version 6)-based communication networks.

IPv4 is a network layer protocol operating according to a 32-bit IP (Internet Protocol) address. However, IPv4 cannot satisfy the need for an increasing number of IP addresses for more Internet users.

To solve the problem of insufficient Internet addresses, the Internet Engineering Task Force (IETF) has suggested the IPv6 as an Internet protocol next generation. IPv6 is based on a 128-bit address. IPv6, which allows for an extended header region in a packet, can define mechanisms guaranteeing packet source authentication, data perfection, and security.

For IPv4-based and IPv6-based communication networks having different protocols IPv4 and IPv6, there has been a need for a tunneling service enabling data communication between a client node in the IPv4-based Internet communication network and a client node in the IPv6-based Internet communication network.

An IPv4/6 dual stack client node has been suggested. An IPv4 IP address and an IPv6 IP address of the IPv4/6 dual stack client node are provided by a DHCP (Dynamic Host Configuration Protocol) server or are input by the client. The IPv4/6 dual stack client node can be connected to a client node linked to an IPv4-based Internet communication network and a client node in an IPv6-based Internet communication network using the IPv4 IP and IPv6 IP addresses. When the IPv4/6 dual stack client node is connected to an IPv6 client node in an IPv6-based Internet communication network, an IPv6-over-IPv4 tunneling service is used.

To use the IPv6-over-IPv4 tunneling service, the IPv4/6 dual stack client node uses the address of a tunnel router or a tunnel end point input by the client. The tunnel router and the tunnel end point are tunneling service servers. Therefore, the client of the IPv4/6 dual stack client node should be aware of the address of the tunnel router or the tunnel end point to be used. In addition, the client of the IPv4/6 dual stack node has to manually update the address of the tunnel router or the tunnel end point whenever the address of the tunnel router or the tunnel end point is altered.

### SUMMARY OF THE INVENTION

According to an aspect of the present invention, there is provided a tunneling service method and system in which an address of a tunneling service server can be easily designated for a client node when a tunneling service enabling data communications between different communication networks is used.

According to an aspect of the present invention, there is provided a tunneling service method and system enabling data communications between different communication networks, in which an address of a tunneling service server can be easily designated for a client node by using dynamic host configuration protocol (DHCP) when an IPv6-over-IPv4 tunneling service is used.

According to an aspect of the present invention, there is provided a tunneling service method for a client node in a network to which the client node, at least one DHCP server, and a tunnel router are connected, the method including: transmitting an information request message, which requests information required for connection to the network, to a DHCP server selected by the client node; receiving an acknowledgement message, which contains an address of the tunnel router, from the DHCP server selected by the client node; and the client node detecting the address of the tunnel router contained in the acknowledgement message and generating a packet for a tunneling service using the detected address of the tunnel router.

According to an aspect of the present invention, the acknowledgement message may be a DHCP message, and the address of the tunnel router may be included in an option field of the DHCP message.

According to an aspect of the present invention, when the tunneling service method is applied to an IPv6-over-IPv4 tunneling service and the client node has an IPv4 IP address and an IPv6 IP address, the generating of the packet may include: generating an IPv6 packet using the IPv6 IP address of the client node and an IPv6 IP address of a node for data communication with the client node; generating an IPv4 packet using the IPv4 IP address of the client node and the address of the tunnel router; and generating the packet for the tunneling service by encapsulating the IPv6 packet in the IPv4 packet.

According to an aspect of the present invention, there is also provided a tunneling service method for a client node in a network to which the client node, a plurality of DHCP servers, and a plurality of tunnel routers are connected, the method including: transmitting an information request message, which requests information required for connection to the network, to a DHCP server selected by the client node; receiving an acknowledgement message, which contains addresses of the plurality of tunnel routers, from the DHCP server selected by the client node; and the client node detecting and storing the addresses of the plurality of tunnel routers contained in the acknowledgement message, selecting the address of one of the tunnel routers, and generating a packet for a tunneling service using the address of the selected tunnel router.

According to another aspect of the present invention, there is provided a client node connected to a DHCP server and using a tunneling service, the client node including: a message transmitting and receiving unit transmitting and receiving a DHCP message with the DHCP server; a storing unit storing address information of the tunnel router; a control unit detecting the address of the tunnel router contained in a message received from the DHCP server via the message transmitting and receiving unit, storing the detected address of the tunnel router in the storing unit, and generating a packet for the tunneling service; and a packet generating unit generating the packet for the tunneling service under the control of the control unit.

According to an aspect of the invention, when there are a plurality of tunnel routers, the control unit may select the address of one of the plurality of tunnel routers to generate the packet for the tunneling service. When an IPv6-over-IPv4 tunneling service is used, the storing unit may store an IPv4 IP address and an IPv6 IP address of the client node in a dual stack.

According to another aspect of the present invention, there is provided a DHCP server supporting a tunneling service for a client node in a network, the server including: a storing unit storing address information of at least one tunnel router connected to the network; a message transmitting and receiving unit transmitting and receiving a DHCP message with the client node; and a control unit generating an option field containing the address information of the tunnel router stored in the storing unit when an information request message, which requests information required for connection to the network, is received from the message transmitting and receiving unit, and transmitting a DHCP message including the option field to the message transmitting and receiving unit.

According to an aspect of the invention, the control unit may update the address information of the tunnel router stored in the storing unit when the address information of the tunnel router is input by an operator of the DHCD server. The control unit may incorporate temporal information for controlling the transmission period of the information request message from the client node into the dynamic host configuration protocol message including the option field.

Additional aspects and/or advantages of the invention will be set forth in part in the description which follows and, in part, will be obvious from the description, or may be learned by practice of the invention.

### BRIEF DESCRIPTION OF THE DRAWINGS

These and or other aspects and advantages of the present invention will become apparent and more readily appreciated from the following description of the embodiments, taken in conjunction with the accompanying drawings of which:

FIG. 1 illustrates a configuration of a tunneling service system according to an aspect of the present invention;

FIG. 2 is a block diagram of an IPv4/6 client node in FIG. 1;

FIG. 3 illustrates a format of a dynamic host configuration protocol (DHCP) message;

FIG. 4 is a table of the descriptions of fields in the DHCP message of FIG. 3;

FIG. 5A illustrates a format of a DHCP message provided from a DHCPv4 server in FIG. 1;

FIG. 5B illustrates a format of a CTEP option field in FIG. 5A;

FIG. 6 is a block diagram of the DHCPv4 server in FIG. 1; and

FIG. 7 is a flowchart illustrating a tunneling service method according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

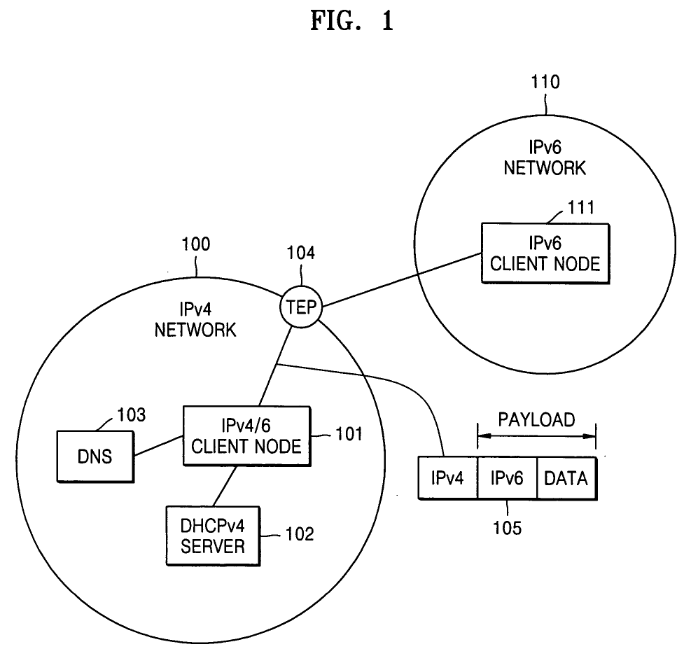

Referring to FIG. 1, a tunnelling service system according to an embodiment of the present invention provides an IPv6-over-IPv4 tunnelling service allowing data communication between an IPv4/6 client node 101 in an IPv4 network 100 and an IPv6 client node 111 in an IPv6 network 110. The IPv4 network 100 is an IPv4-based Internet communication network, and the IPv6 network 110 is an IPv6-based Internet communication network.

As shown in FIG. 1, the IPv4 network 100 includes the IPv4/6 client node 101, a dynamic host configuration protocol (DHCPv4) server 102, a domain name server (DNS) 103, and a tunnel end point (TEP) 104. The IPv4 network 100 may include a plurality of DHCPv4 servers. The IPv6 network 110 includes an IPv6 client node 111.

The IPv4/6 client node 101 manages Internet Protocol (IP) addresses using a dual stack configuration. An IP address of the IPv4/6 client node 101 in the IPv4 network 100 is provided by the DHCPv4 server 102 or is input by the client. An IP address of the IPv4/6 client node 101 in the IPv6 network 110 is input by the client. The IP addresses of the IPv4/6 client node 101 in the IPv4 network 100 and the IPv6 network 110 are stored in separate stacks. The IP addresses stored in the stacks are used as source addresses of the IPv4/6 client node 101 when the IPv4/6 client node 101 performs data communication with other client nodes.

The IPv4/6 client node 101 uses an IPv6-over-IPv4 tunneling service for data communication with the IPv6 client node 111. To use a tunneling service, the IPv4/6 client node 101 receives an IP address of the IPv6 client node 111, which is designated for data communication, from the DNS 103 and receives an IP address of the TEP 104, which is a tunnelling service server, from the DHCPv4 server 102. When the IP address of the TEP 104 is received from the DHCPv4 server 102, the IPv4/6 client node 101 generates a packet 105 for IPv6-over-IPv4 tunnelling and transmits the packet 105 to the TEP 104.

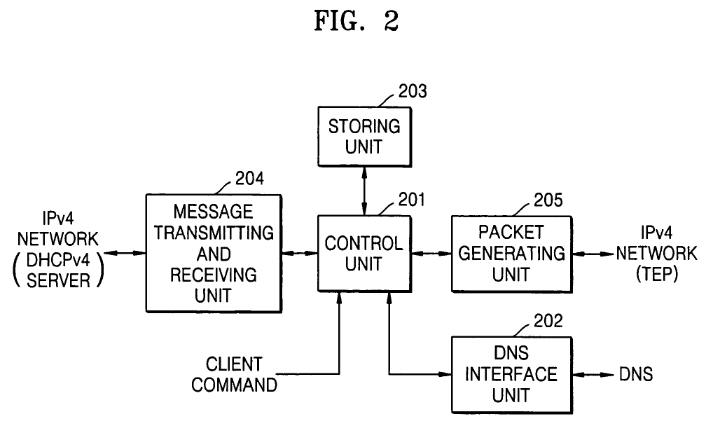

For the operation described above, the IPv4/6 client node 101 includes a control unit 201, a DNS interface unit 202, a storing unit 203, and a message transmitting and receiving unit 204, and a packet generating unit 204, as shown in FIG. 2.

When an IPv6-over-IPv4 tunnelling service is used for a connection requested by a client, the control unit 201 receives an IP address of the IPv6 client node 111, which is designated for connection, from the DNS 103 via the DNS interface unit 202. The received address of the IPv6 client node 111 is stored in the storing unit 203 under the control of the control unit 201.

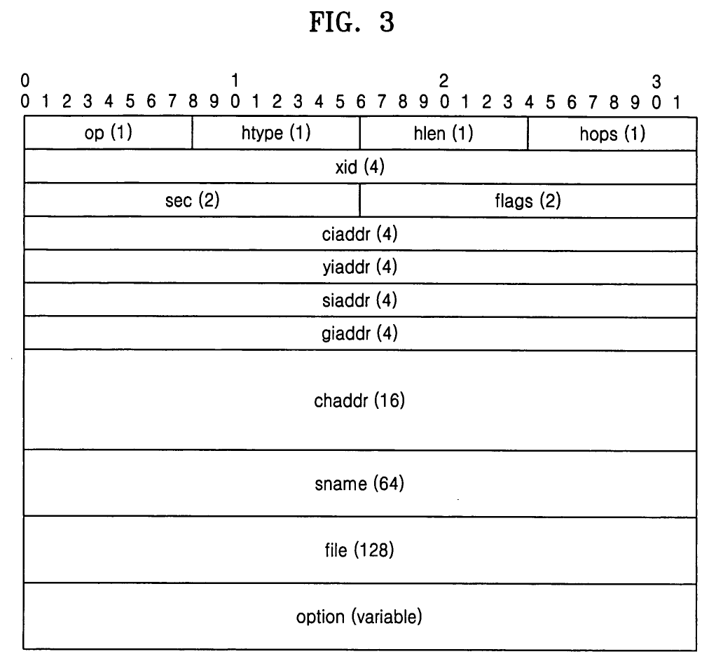

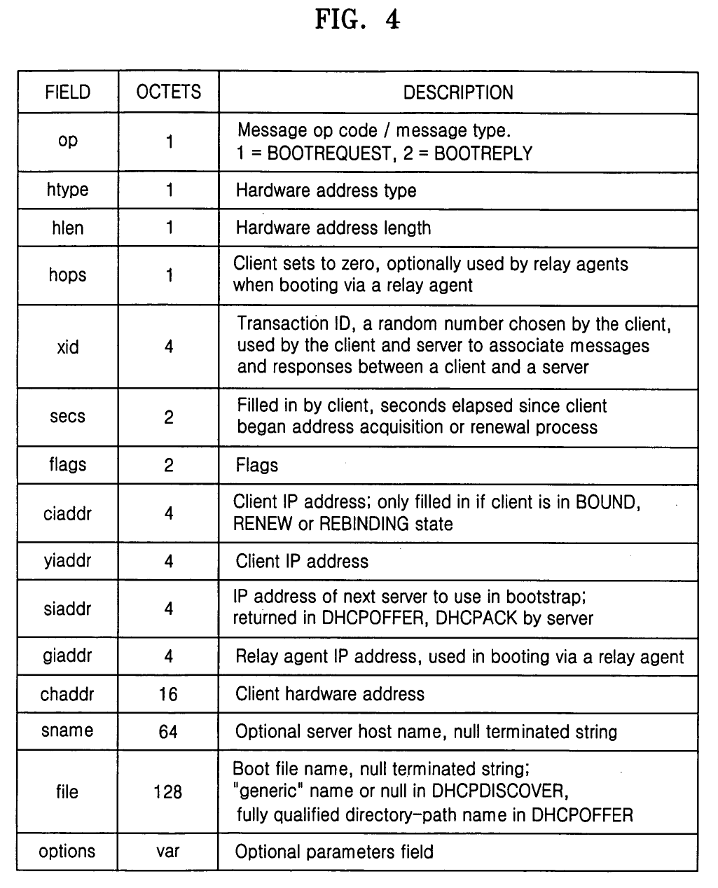

The control unit 201 controls the message transmitting and receiving unit 204 to broadcast a DHCP message DHCPDISCOVER indicating that a DHCPv4 server is being searched for. The DHCP message has a format illustrated in FIG. 3. Descriptions of fields of the DHCP message of FIG. 3 are in FIG. 4. Although not illustrated in FIG. 1, a relay agent appearing in FIG. 4 may exist between the IPv4/6 client node 101 and the DHCP4 server 102.

When the message transmitting and receiving unit 204 receives a DHCPOFFER message, the control unit 201 selects a DHCPv4 server based on the received DHCPOFFER message. The control unit 201 can select a DHCPv4 server based on the order in which the DHCPOFFER messages are received or DHCPv4 server information in an option field of each of the DHCPOFFER messages. The DHCPv4 server information that can be included in the option field may be priority information of the DHCPv4 servers in the IPv4 network 100. If only one DHCPOFFER message is received, a DHCPv4 server that sent the received DHCPOFFER message is selected.

When a DHCPv4 server is selected, the control unit 201 broadcasts a DHCPREQUEST message, which is based on the information included in the DHCPOFFER message received from the selected DHCPv4 server, to the IPv4 network 100 via the message transmitting and receiving unit 204. The DHCPREQUEST message is a message that requests network connection information, which is necessary for connection to the network. The DHCPREQUEST message may include the IP address of the IPv4/6 client node 101, and the IP address and ID information of the DHCPv4 server that sent the DHCPOFFER message, which are included in the DHCPOFFER message. If the selected DHCPv4 server is the DHCPv4 server 102, the DHCPv4 server 102 receives the broadcasted DHCPREQUEST message.

When the message transmitting and receiving unit 204 receives a DHCPACK message, which is an acknowledgement (ack) message acknowledging receipt of the DHCPREQUEST message, from the DHCPv4 server 102, the control unit 201 detects an IPv4 IP address included in the received DHCPACK message and stores it in an IP address stack for IPV4 (not shown). The control unit 201 detects the address of the TEP 103 and stores it in the storing unit 203. An IPv6 IP address of the IPv4/6 client node 101 is input by the client. The control unit 201 stores the IPv6 IP address input by the client in an IP address stack for IPv6 (not shown).

The IP stack for IPv6 and the IP stack for IPv4 may be included in either the control unit 201 or the storing unit 203. If the IP stacks for IPv6 and IPv4 are included in the storing unit 203, the IPv4 IP address and IPv6 IP address of the IPv4/6 client node 101 are stored in the storing unit 203.

When the DHCPACK message includes network connection information, which is necessary for connection to the network, such as mask information of the IPv4 network 100, default gateway information, etc., the control unit 201 stores such necessary network connection information in the storing unit 203.

The message transmitting and receiving unit 204 broadcasts the DHCP message to the IPV4 network 100 under the control of the control unit 201 and provides a received DHCP message to the control unit 201. When one of DHCPv4 servers in the IPC4 network 100 is selected, the message transmitting and receiving unit 204 transmits and receives a DHCP message with the selected DHCPv4 server under the control of the control unit 201.

The control unit 201 controls the packet generating unit 205 to generate an IPv6 packet including the IPv6 IP address in the stack as a source address and the previously received address of the IPv6 client node 111 as a destination address.

The control unit 201 controls the packet generating unit 204 to generate an IPv4 packet including the IPv4 IP address in the stack as a source address and the address of the TEP 104, which is stored in the storing unit 203, as a destination address. The control unit 201 controls the packet generating unit 205 to transmit to the TEP 104 a packet in which the IPv6 packet is encapsulated in the IPV4 packet.

When a plurality of TEP addresses are received from the DHCPv4 server 102, the control unit 201 selects one of the TEP addresses to generate the IPv4 packet. The control unit 201 may select one of the TEP addresses according to a round-robin method. In this case, the traffic to the TEPs in the IPv4 network 100 can be distributed. A plurality of TEP addresses may be received when the IPv4 network includes a plurality of TEPs.

To update the TEP address, the control unit 201 can transmit a DHCPREQUEST message to the DHCPv4 server 102 based on temporal information included in the received DHCPACK message. In particular, the control unit 201 may monitor time and transmit the DHCPREQUEST message to the DHCPv4 server 102 within a time limit based on the temporal information.

The packet generating unit 205 generates the packet 105 as shown in FIG. 1 under the control of the control unit 201 for IPv6-over-IPv4 tunneling and transmits the generated packet to the IPv4 network 100. The TEP 104 receives the packet 105.

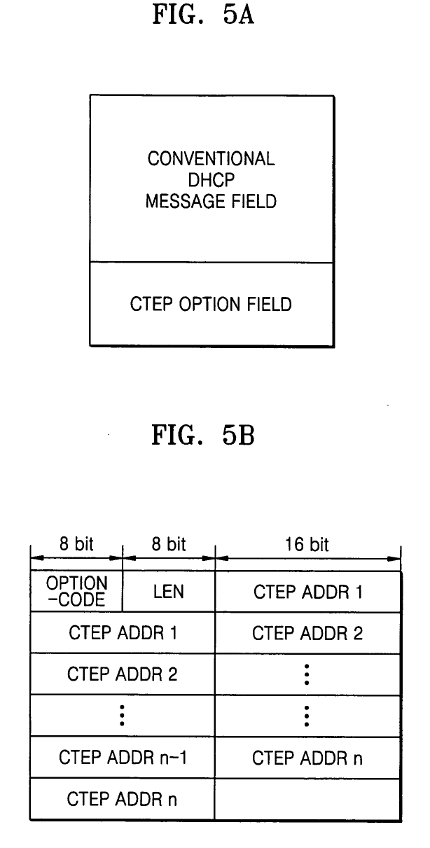

The DHCPv4 server 102 in FIG. 1 provides the TEP address to the IPv4/6 client node 101 using the option field of the DHCP message of FIG. 3. In particular, a DHCP message in which a conventional DHCP message field and a configured port tunnel end point (CTEP) option field, which is an additional field according to the present invention, are combined, as illustrated in FIG. 5A, is transmitted to IPv4/6 client node 101 as the DHCPACK message. The CTEP option field is one of optional parameters that can be defined in the option field in FIG. 3.

As shown in FIG. 5B, the CTEP option field in FIG. 5A includes an 8-bit option field type information (OPTION_CODE), an 8-bit information length information (LEN), and a plurality of 16-bit TEP addresses (CTEP ADDR 1 through CTEP ADDR n). Only one 16-bit TEP address may be included in the CTEP option field when the IPV4 network 100 includes one TEP 104.

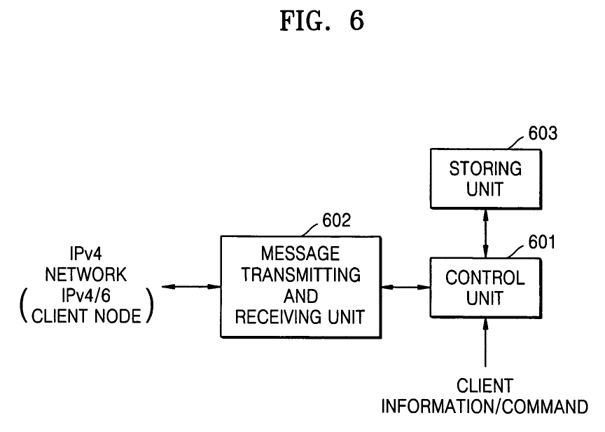

FIG. 6 is a block diagram of the DHCPv4 server 102. Referring to FIG. 6, the DHCPv4 server 102 includes a control unit 601, a message transmitting and receiving unit 602, and a storing unit 603.

When the message transmitting and receiving unit 602 receives the DHCPDISCOVER message broadcasted from the IPv4/6 client node 101, the control unit 601 controls the message transmitting and receiving unit 602 to broadcast a DHCPOFFER message. The DHCPOFFER message includes the IP address and ID information of the DHCPv4 server 102 and the IPv4 IP address of the IPv4/6 client node 101 to the IPv4 network 100.

After the DHCPOFFER message is transmitted and a DHCPREQUEST message, which requests necessary network connection information, is received from the IPv4/6 client node 101, the control unit 601 reads the network connection information including the address of the TEP 104 from the storing unit 603. The control unit 601 generates a CTEP option field based on the network connection information read from the storing unit 603, generates a DHCPACK message including the CTEP option field, and transmits the DHCPACK message to the IPV4/6 client node 101 via the message transmitting and receiving unit 602.

When the address of the TEP 104 in the IPv4 network 100 is altered or when another TEP is added into the IPv4 network 100, the TEP address stored in the storing unit 603 and the CTEP option field are updated. The updated address of the TEP 104 or the address of the additional TEP may be input by an operator of the DCPv4 server 102.

The control unit 601 reads the TEP address from the storing unit 603 whenever a DHCPREQUEST message, which requires the CTEP option field, is received from the IPv4/6 client node 101, and transmits a DHCPACK message including the CTEP option field to the IPv4/6 client node 101.

The message transmitting and receiving unit 602 receives and transmits a DHCP message from the IPv4/6 client node 101 in the IPv4 network 100 under the control of the control unit 601. The storing unit 603 stores addresses of TEPs in the IPv4 network 100. The storing unit 603 can store any network connection information requested by the IPv4/6 client node 101.

Domain names and addresses of IPv6 client nodes are registered with the DNS 103 in FIG. 1. When the IPv4/6 client node 101 requests an address of the IPv6 client node 111, the DNS 103 provides an IPV6 IP address of the IPv6 client node 111 based on the domain name of the IPv6 client node 111 to the IPv4/6 client node 101.

The TEP 104 of FIG. 1 is a tunneling service server. The TEP 104 can be also referred to as a tunnel router. When the packet 105 is received from the IPv4/6 client node 101, the TEP 104 decapsulates the IPv4 packet to detect the IPV6 packet and transmits the detected IPv6 packet to the IPv6 network 110. When the IPv6 packet is received from the IPv6 network 110, the TEP 104 encapsulates the received IPv6 packet in the IPV4 packet received from the IPv4/6 client node 101 and transmits the encapsulated packet to the IPv4/6 client node 101.

The IPv6 client node 111 receives the IPv6 packet transmitted from the TEP 104 via the IPv6 network 110. The IPv6 client node 111 receives the IPv6 packet using the destination address included in the IPv6 packet. The IPv6 client node 111 processes data included in a payload area of the received IPv6 packet and transmits a corresponding IPv6 packet to the IPv6 network 110. A destination address included in the IPv6 packet transmitted from the IPv6 client node 111 is the IPv6 IP address of the IPv4/6 client node 101. The IPv6 IP address of the IPv4/6 client node is managed in the TEP 104. Accordingly, the TEP 104 receives the IPv6 packet transmitted from the IPv6 client node 111.

The IPv6 client node 111, which functions according to IPv6, may be a mobile node, such as a notebook computer or a personal digital assistant (PDA), or a non-mobile node such as a desktop computer. The IPv4/6 client node 101, which functions according to IPv4 and IPv6, may be a mobile node, such as a notebook computer or a PDA, or a non-mobile node, such as a desktop computer.

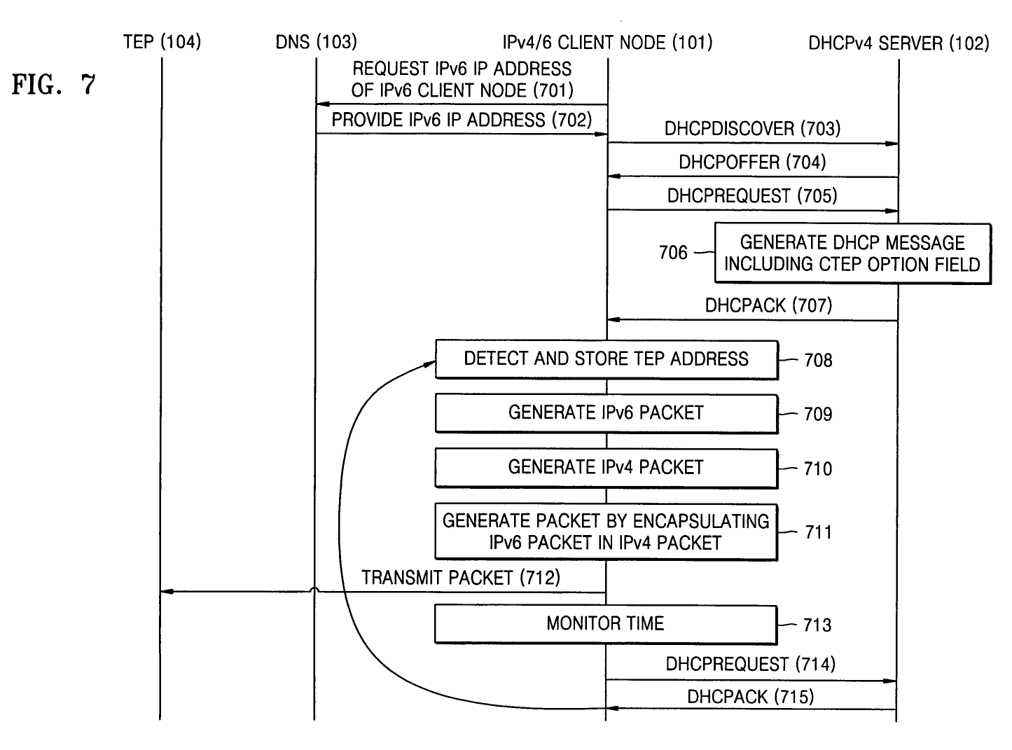

FIG. 7 is a flowchart of a tunneling service method according to an embodiment of the present invention.

When the client inputs a domain name of the IPv6 client node 111, the IPv4/6 client node 101 requests the DNS 103 for the IPv6 IP address of the IPv6 client node 111 (operation 701). When the IPv6 IP address of the IPv6 client node 111 is received from the DNS 103 (operation 701), the IPv4/6 client node 101 broadcasts DHCPDISCOVER messages to the IPV4 network 100 (operation 703).

DHCPv4 servers in the IPv4 network 100 receive the DHCPDISCOVER messages, and the DHCPv4 servers broadcast a DHCPOFFER message (operation 704). The IPv4/5 client node 101 selects a DHCPv4 server based on the information contained in the received DHCPOFFER message. If the IPv4/6 client node 101 selects the DHCPv4 server 102, the IPv4/6 client node 101 broadcasts a DHCPREQUEST message containing the IP address and ID information of the DHCPv4 server 102 and the IPv4 IP address of the IPv4/6 client node 101 to the IPv4 network 100 (operation 705). The DHCPv4 server 102 receives the DHCPREQUEST message.

The DHCPv4 server 102 generates a CTEP option field as illustrated in FIG. 5B and generates a DHCP message including the CTEP option field (operation 706). The CTEP option field includes at least one TEP address. Addresses of all TEPs in the IPv4 network 100 are included in the CTEP option field. The DHCPv4 server 102 transmits the DHCPACK message including the CTEP option field to the IPv4/6 client node 101 (operation 707).

The IPv4/6 client node 101 detects and stores the TEP address CTEP ADDR included in the CTEP option field of the received DHCPACK message (operation 708). When there is a plurality of TEP addresses, the IPv4/6 client node 101 can select one TEP. The IPv4/6 client node 101 generates an IPv6 packet using the IPv6 IP address thereof previously stored in a stack and the IP address of the IPv6 client node 111 obtained in operation 702 (operation 709).

The IPv4/6 client node 101 generates an IPv4 packet using the IPv4 IP address thereof previously stored in a stack and the TEP address (operation 710).

The IPv4/6 client node 101 encapsulates the IPv6 packet in the IPv4 packet (operation 711). The IPv4/6 client node 101 transmits the encapsulated packet to the TEP 104 via the IPv4 network 100 (operation 712).

The IPv4/6 client node 101 monitors time based on the temporal information included in the transmitted DHCPACK message (operation 713). The IPv4/6 client node 101 transmits the DHCPREQUEST message to the DHCPv4 server 102 within a time limit defined in the temporal information to update the TEP address stored therein (operation 714).

The DHCPv4 server 102 transmits the DHCPACK message including the CTEP option field with the stored TEP address to the IPv4/6 client node 101. In this way, the IPv4/6 client node 101 can periodically receive TEP addresses from the DHCPv4 server 102. The IPv4/6 client node 101 returns to operation 708 and repeats the above-described operations.

As described above, according to the present invention, a client can be automatically provided with the address of a tunneling service server, which may be a tunnel router or a tunnel end point, by the DHCPv4 server when using an IPv6-over-IPv4 tunneling service. Therefore, there is no need for the client to input the address of the tunneling service server when the address of the tunneling service server is altered, and IPv6-over-IPv4 tunneling can be achieved. When a client is unaware of the address of the tunneling service server, an IPv6-over-IPv4 tunneling service can be provided.

The client node can periodically provide the address of the tunneling service server.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A tunneling service method of a client node in a network to which the client node, at least one dynamic host configuration protocol (DHCP) server, and a tunnel router are connected, the method comprising:
transmitting an information request message, which requests information required for connection to the network, to the at least one DHCP server selected by the client node;
receiving an acknowledgement message, which contains an address of the tunnel router, from the DHCP server selected by the client node; and
the client node detecting the address of the tunnel router contained in the acknowledgement message and generating a packet for a tunneling service using the detected address of the tunnel router.

2. The tunneling service method of claim 1, wherein the acknowledgement message is a dynamic host configuration protocol (DHCP) message, and the address of the tunnel router is included in an option field of the DHCP message.

3. The tunneling service method of claim 1, wherein the information request message is periodically transmitted based on temporal information included in the acknowledgement message.

4. The tunneling service method of claim 1, which when applied to an IPv6-over-IPv4 tunneling service and the client node having an IPv4 IP address and an IPv6 IP address, the generating of the packet comprises:
generating an IPv6 packet using the IPv6 IP address of the client node and another IPv6 IP address of a node for data communication with the client node;
generating an IPv4 packet using the IPv4 IP address of the client node and the address of the tunnel router; and
generating the packet for the tunneling service by encapsulating the IPv6 packet in the IPv4 packet.

5. A tunneling service method of a client node in a network to which the client node, a plurality of dynamic host configuration protocol (DHCP) servers, and a plurality of tunnel routers are connected, the method comprising:
transmitting an information request message, which requests information required for connection to the network, to at least one DHCP server selected by the client node;
receiving an acknowledgement message, which contains addresses of the plurality of tunnel routers, from the at least one DHCP server selected by the client node; and
the client node detecting and storing the addresses of the plurality of tunnel routers contained in the acknowledgement message, selecting an address of one of the tunnel routers, and generating a packet for a tunneling service using the address of the selected tunnel router.

6. The tunneling service method of claim 5, wherein the packet is generated by encapsulating an IPv6 packet in an IPv4 packet.

7. The tunneling service method of claim 5, wherein the client node is automatically provided with the addresses of the plurality of tunnel routers.

8. A client node connected to a dynamic host configuration protocol (DHCP) server and using a tunneling service, the client node comprising:
a message transmitting and receiving unit transmitting and receiving a DHCP message from the DHCP server;
a storing unit storing address information of a tunnel router;
a control unit detecting an address of the tunnel router contained in a message received from the DHCP server via the message transmitting and receiving unit, storing the detected address of the tunnel router in the storing unit, and generating a packet for the tunneling service; and
a packet generating unit generating the packet for the tunneling service under control of the control unit.

9. The client node of claim 8, wherein, when there are a plurality of tunnel routers, the control unit selects an address of one of the plurality of tunnel routers to generate the packet for the tunneling service.

10. The client node of claim 8, wherein, when an IPv6-over-IPv4 tunneling service is used, the storing unit stores an IPv4 IP address and an IPv6 IP address of the client node in a dual stack.

11. The client node of claim 10, wherein the control unit generates an IPv6 packet using the IPv6 IP address of the client node and another IPv6 IP address of a node for data communication with the client node, generates an IPv4 packet using the IPv4 IP address of the client node and the address of the tunnel router, and generating the packet for the tunneling service by encapsulating the IPv6 packet in the IPv4 packet.

12. The client node of claim 8, wherein the client node includes a mobile node, or a non-mobile node.

13. A dynamic host configuration protocol (DHCP) server supporting a tunneling service for a client node in a network, the DHCP server comprising:
a storing unit storing address information of at least one tunnel router connected to the network;
a message transmitting and receiving unit transmitting and receiving a DHCP message with the client node; and
a control unit generating an option field containing the address information of the at least one tunnel router stored in the storing unit when an information request message, which requests information required for connection to the network, is received from the message transmitting and receiving unit, and transmitting the DHCP message including the option field to the message transmitting and receiving unit.

14. The dynamic host configuration protocol server of claim 13, wherein the control unit updates the address information of the at least one tunnel router stored in the storing unit when the address information of the at least one tunnel router is input by an operator of the DHCD server.

15. The dynamic host configuration protocol of claim 13, wherein the control unit incorporates temporal information for controlling a transmission period of the information request message from the client node into the DHCP message including the option filed.

16. A tunneling service method of a client node in a network, the method comprising:
transmitting an information request message requesting information for connecting to the network;
receiving an acknowledgement message containing an address of a tunnel router for connecting to the network; and
detecting the address of the tunnel router contained in the acknowledgement message and generating a packet for a tunneling service using the detected address of the tunnel router.

17. The tunneling service method of claim 16, wherein the acknowledgment message is a dynamic host configuration protocol (DHCP) message, and the address of the tunnel router is included in the DHCP message.

18. The tunneling service method of claim 16, wherein the packet is generated by encapsulating an IPv6 packet in an IPv4 packet.

19. The tunneling service method of claim 16, wherein the client node is automatically provided with the addresses of the plurality of tunnel routers.

20. The tunneling service method of claim 18, wherein the IPv4 packet is generated using an IPv4 IP address of the client node and the address of the tunnel router, and the IPv6 packet is generated using an IPv6 IP address of the client node and another IPv6 IP address of another node for data communication with the client node.
